(19) United States
(12) Patent Application Publication
(10) Pub. No.: US 2014/0236424 A1
(43) Pub. Date: Aug. 21, 2014

(54) FLUID DELIVERY SYSTEM

(71) Applicant: Caterpillar Inc., Peoria, IL (US)

(72) Inventors: Kenneth L. Stratton, Dunlap, IL (US); Mark M. Sheehan, Germantown Hills, IL (US)

(73) Assignee: Caterpillar Inc., Peoria, IL (US)

(21) Appl. No.: 14/263,043

(22) Filed: Apr. 28, 2014

(51) Int. Cl. B60R 1/00

(52) U.S. Cl. CPC B60R 1/002
USPC 701/36

(57) ABSTRACT

A system for a machine operating on a worksite is provided. The system includes an image capturing device configured to provide an image feed associated with a fluid dispensing arrangement of the machine. The system includes a position detection module configured to generate a position signal indicative of a current position of the machine on the worksite. A controller is communicably coupled to the image capturing device and the position detection module. The controller is configured to receive the image feed and the position signal. The controller is configured to detect a discharge of a fluid from the machine based on the image feed. Further, the controller is configured to determine an area of the worksite in which the fluid is discharged based on the detection and the position signal.

### TECHNICAL FIELD

The present disclosure relates to a fluid delivery system, and more specifically to a machine including the fluid delivery system for dispensing a pressurized fluid.

### BACKGROUND

Fluid distribution systems, in particular mobile fluid distribution systems, are used in a variety of applications. For example, at mining and construction sites, it is common to use mobile fluid distribution systems to spray water over roads and work areas to minimize the creation of dust during operations. A specific example might include a water truck that sprays water over roads at a mine site. These water trucks may include manned, autonomous or semi-autonomous machines that distribute water to different areas of the mine site on which the water truck operates.

U.S. Published Application Number 2011/0160919 discloses a system and method for delivering fluid to a site using a mobile fluid delivery machine. The method includes determining a value of a parameter associated with the site using a sensor, and determining a fluid delivery rate based on the value of the site parameter. The method further includes delivering the fluid to a surface of the site at the location of the mobile fluid delivery machine, at the determined fluid delivery rate.

### SUMMARY OF THE DISCLOSURE

In one aspect of the present disclosure, a system for a machine operating on a worksite is provided. The system includes an image capturing device configured to provide an image feed associated with a fluid dispensing arrangement of the machine. The system includes a position detection module configured to generate a position signal indicative of a current position of the machine on the worksite. A controller is communicably coupled to the image capturing device and the position detection module. The controller is configured to receive the image feed and the position signal. The controller is configured to detect a discharge of a fluid from the machine based on the image feed. Further, the controller is configured to determine an area of the worksite in which the fluid is discharged based on the detection and the position signal.

Other features and aspects of this disclosure will be apparent from the following description and the accompanying drawings.

### BRIEF DESCRIPTION OF THE DRAWINGS

FIG. 1 is perspective view of an exemplary machine, according to one embodiment of the present disclosure;

FIG. 2 is a block diagram of an exemplary fluid delivery detection system employed on the machine; and

FIG. 3 is a block diagram of a number of the fluid delivery detection systems in communication with a remote control station, according to some embodiments of the present disclosure.

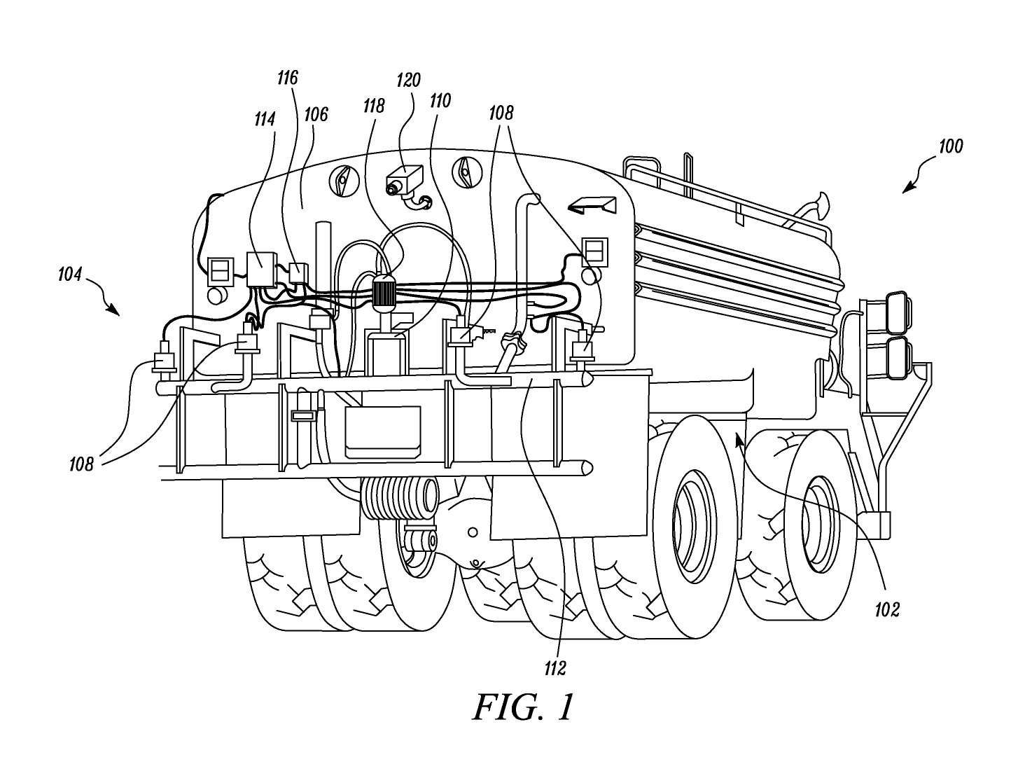

### DETAILED DESCRIPTION

Wherever possible, the same reference numbers will be used throughout the drawings to refer to the same or the like parts. FIG. 1 illustrates an exemplary embodiment of a machine 100 according to the present disclosure. The machine 100 may be configured to dispense a pressurized fluid. The machine 100 of FIG. 1 is shown as a truck, typically used in off-highway applications, capable of dispensing the pressurized fluid. However, other types of mobile machines may be employed, for example, articulated trucks, on-highway trucks, tractor-scrapers, tractors in combination with trailers, or the like.

The machine 100 may include a variety of piping, hoses, pumps and valves for fluid transmission and/or distribution purposes. In particular, the machine 100 in FIG. 1 is shown as an off-highway truck configured as a water truck for spraying water at a worksite. However, the present disclosure may also apply to other types of mobile machines configured to distribute water or other types of fluids in a wide variety of applications. For example, a tractor pulling a trailer may be used to distribute chemicals in agricultural settings, an on-highway truck may be configured to spray a saline solution on roads, runways, or parking lots to melt snow and ice, or other varieties of applications and setups may be used.

The machine 100 includes an engine (not shown), for example, an internal combustion engine or any other power source, which may be supported on a frame 102 of the machine 100. Although different arrangements and setups are contemplated, as shown in FIG. 1, the machine 100 may include among other systems, a fluid dispensing arrangement 104 disposed on the frame 102. The fluid dispensing arrangement 104 may be powered by the engine. Further, the engine may be configured to provide power to a number of other systems and devices (not shown) in addition to the fluid dispensing arrangement 104. The fluid dispensing arrangement 104 may include a fluid source 106 and one or more spray heads 108 fluidly connected thereto.

The fluid dispensing arrangement 104 further includes a delivery pump 110 mechanically coupled to a motor 118 and fluidly connected to the fluid source 106. The delivery pump 110 is configured to deliver the pressurized fluid. In an embodiment, the fluid source 106 may be a third tank configured to store a third fluid different from the first working fluid and the second working fluid.

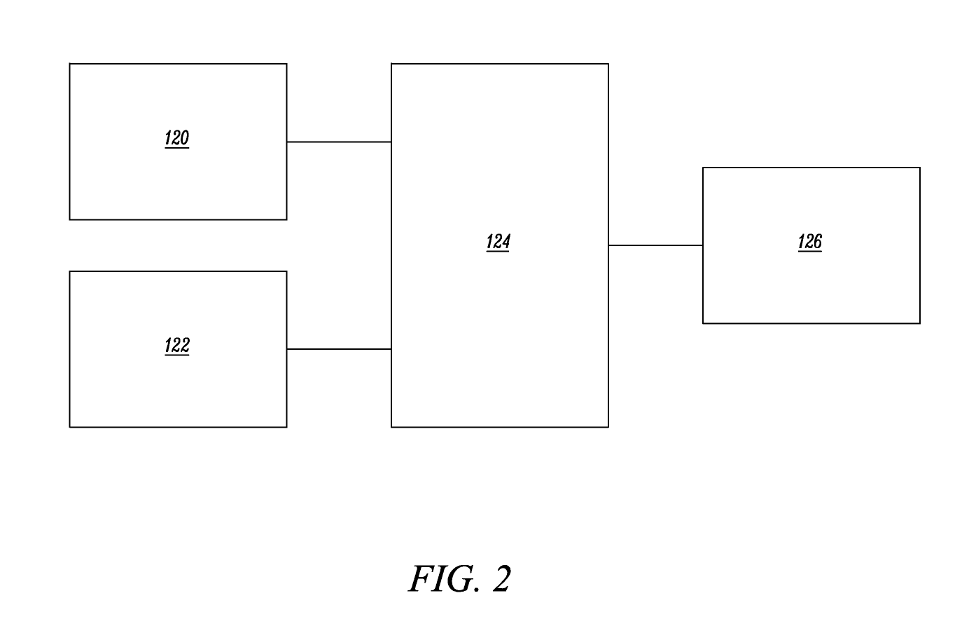

In an embodiment, as shown in FIG. 1, the fluid dispensing arrangement 104 further includes a fluid manifold 112, and the spray heads 108 mounted onto the fluid manifold 112 (four spray heads 108 shown in FIG. 1). The fluid manifold 112 (as shown in FIGS. 1 and 2) may be fluidly coupled to the delivery pump 110 and configured to receive the pressurized fluid from the delivery pump 110. The spray heads 108 may be configured to dispense the pressurized fluid. Although four spray heads 108 are shown in accompanying figures, it is to be noted that a number of the spray heads 108 mounted onto the fluid manifold 112 is merely exemplary in nature and hence, non-limiting of this disclosure. Any number of the spray heads 108 may be employed in the fluid dispensing arrangement 104 depending on specific requirements of an application. Moreover, the spray heads 108 may be mounted on the machine 100 at any desired location or orientation to provide suitable coverage of the worksite. In one embodiment, the spray heads 108 may be positioned as to provide a desired spray pattern having a width suitable to cover a predetermined surface area of the worksite, such as a portion of a typical mine haul road, without having the various sprays overlap.

As shown in FIG. 1, the fluid dispensing arrangement 104 may further include an electronic control module (ECM) 114 electrically connected to the motor 118. In an embodiment, the ECM 114 may control one or more actuators (not shown) associated with the motor 118 of the fluid dispensing arrangement 104. Further, the ECM 114 may be electrically connected to a pressure sensor (not shown) located at the fluid manifold 112 and the spray heads 108 via one or more solenoids 116.

The ECM 114 may be configured to modulate a speed of the motor 118 such that a fluid output from the delivery pump 110 is varied, i.e., a flow rate and/or pressure of the fluid from the delivery pump 110 are varied. Varying the fluid output from the delivery pump 110 may increase or decrease a pressure of the fluid in the fluid manifold 112 such that the spray heads 108 may dispense the fluid at an increased or decreased flow rate and/or pressure. In one embodiment, the dispensing of the fluid from the machine 100 is based on an operator command. Based on the operator command, the ECM 114 may transmit corresponding control signals for controlling an operation of the spray heads 108 of the fluid dispensing arrangement 104.

As shown in FIGS. 1 and 2, an image capturing device 120 is present on-board the machine 100. The image capturing device 120 may include a camera, a video camera or any other imaging device known in the art. The image capturing device 120 may be positioned proximate to the fluid dispensing arrangement 104. In one embodiment, as illustrated in FIG. 1, the image capturing device 120 is positioned at a rear end of the machine 100 such that a lens of the image capturing device 120 is focused on the spray heads 108. The image capturing device 120 is configured to generate an image feed associated with the fluid dispensing arrangement 104. More particularly, the image feed may be indicative of whether fluid is being dispensed form the spray heads 108. In one embodiment, the image capturing device 120 may be activated based on a state of the engine of the machine 100.

It should be noted that the functionality of the image capturing device 120 may be integrated with that of a rear view camera of the machine 100. Alternatively, the image capturing device 120 may be a dedicated imaging device associate with the fluid dispensing arrangement 104 on-board the machine 100. Location and number of the image capturing devices 120 may vary based on the system requirements.

The machine 100 may also include a position detection module 122. The position detection module 122 is configured to generate a signal of a current position of the machine 100 on a worksite. The position detection module 122 may be any one or a combination of a Global Positioning System, a Global Navigation Satellite System, a Pseudolite/Pseudo-Satellite, any other Satellite Navigation System, an Inertial Navigation System or any other known position detection system known in the art.

In one embodiment, the machine 100 may additionally include an orientation sensor (not shown) configured to generate a signal indicative of a heading direction and/or an inclination of the machine 100 on the surface of the worksite. For example, the orientation sensor may include, but not limited to, a laser-level sensor, a tilt sensor, inclinometer, a radio direction finder, a gyrocompass, a fluxgate compass, or another known device operable to determine a relative pitch, yaw, and/or roll of the machine 100 as the machine 100 operates about the worksite.

Referring to FIG. 2, the image capturing device 120 and the position detection module 122 may be communicably coupled to a controller 124. The controller 124 is located on-board the machine 100. Alternatively, the controller 124 may be located at a remote location. The controller 124 is configured to receive the image feed from the image capturing device 120. In one embodiment, the image capturing device 120 may be activated based on signals from the controller 124. For example, the controller 124 may activate the image capturing device 120 corresponding to actuation of the motor 118 of the fluid dispensing arrangement 104. Also, the controller 124 is configured to receive the position signal from the position detection module 122. Further, the controller 124 is configured to process the image feed so as to determine if the fluid is being discharged from the machine 100. The controller 124 may make use of any image processing technique or algorithm known in art in order to detect the discharge of the fluid from the spray heads 108 of the machine 100 based on the image feed.

Additionally, based on the position signal, the controller 124 is configured to determine whether the fluid is discharged on a given area of the worksite on which the machine 100 operates. For example, in case of the water truck, when the spray heads 108 discharge water therefrom, the camera mounted on the water truck provides the image feed to the controller 124. Based on a path of travel of the water truck, the controller 124 determines the area of the worksite on which the water discharged. In another example, the controller 124 may determine a portion of the worksite which has not received water from the water truck.

In one embodiment, the controller 124 is communicably coupled to a display unit 126 present within an operator cabin of the machine 100. Accordingly, the display unit 126 may be configured to notify the operator of the machine 100 of the discharge of the fluid on the worksite. The display unit 126 may include any screen, monitor or display panel known in the art. An exemplary display of the display unit 126 includes providing a outline or demarcation of the area on which fluid is discharged on a map of the worksite.

In some embodiments of the disclosure, the controller 124 may further be coupled to one or sensors or components of the fluid dispensing arrangement 104 in order to determine a quantity of the fluid discharged by the machine 100. More particularly, based on one or more parameters associated with a flow of the fluid from the fluid dispensing arrangement 104, the controller 124 may determine the quantity of the fluid discharged from the spray heads 108. The one or more parameters may include, but not limited to, an area of the spray heads 108, pressure of the fluid being discharged from the spray heads 108, speed of the delivery pump 110 and so on.

Further, the controller 124 may also be configured to determine if the area is receiving a required amount of the fluid. The controller 124 may be configured to receive signals indicative of a speed and/or the heading direction of the machine 100 in order to determine if the estimated quantity of the fluid is being discharged in a localized area on the worksite. For example, in a situation wherein the machine 100 is in a stationary position on the worksite and a relatively large quantity of the fluid is being discharged in the given area on the worksite, the controller 124 may determine that the area is being flooded.

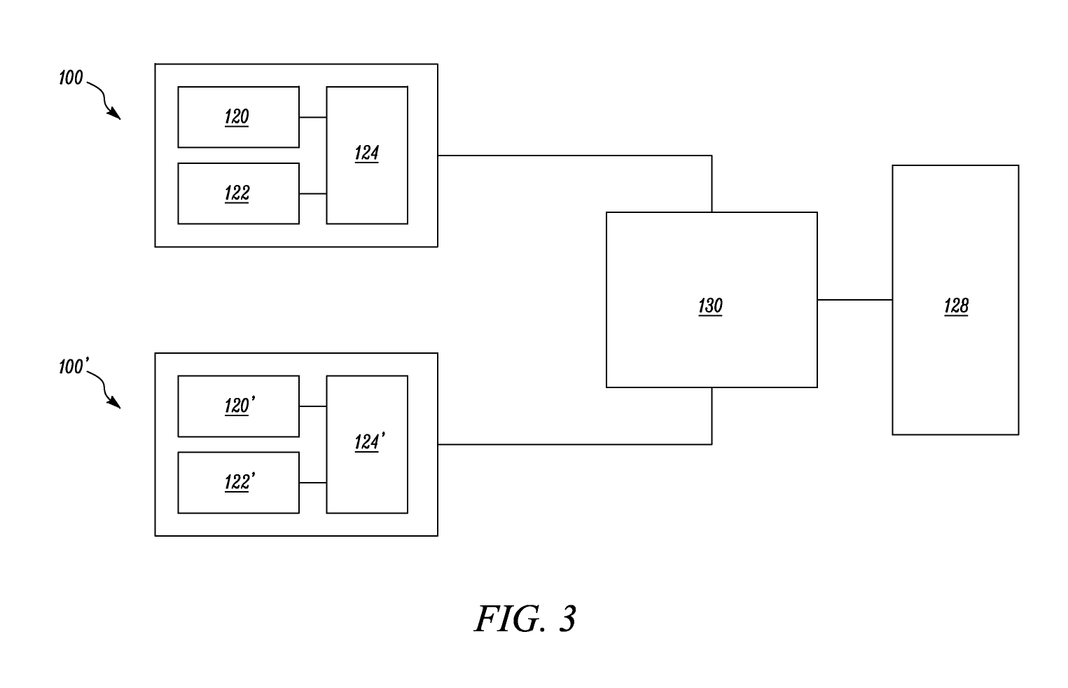

Referring to FIG. 3, the controllers 124, 124′ present on-board various machines 100, 100′ may be communicably coupled to a remote control station 128 via a communication system 130. It should be noted that although two controllers 124 and 124′ are shown associated with the respective machines 100 and 100′, the system may include any number of such machines and is not limited to the implementation shown in the accompanying figures. The communication system 130 may include, but not limited to, a wide area network (WAN), a local area network (LAN), an Ethernet, Internet, an Intranet, a cellular network, a satellite network, or any other suitable network for transmitting data between the machines 100, 100′ and the remote control station 128. In various embodiments, the communication system 130 may include a combination of two or more of the aforementioned networks and/or other types of networks known in the art. The communication system 130 may be implemented as a wired network, a wireless network or a combination thereof. Further, data transmission between the machines 100, 100′ and the remote control station 128 may occur over the communication system 130 in an encrypted or otherwise secure format, in any of a wide variety of known manners.

The remote control station 128 may be located away from the worksite. The remote control station 128 may be configured to receive and store data related to the discharge of the fluid from each of the machines 100, 100′. Further, the remote control station 128 may monitor the data received from the machines 100, 100′. The remote control station 128 may be configured to map the data related to the discharge of the fluid against a pre-calibrated data set including fluid delivery data associated the worksite. This pre-calibrated data may include information related to co-ordinates and/or predetermined volume of the fluid to be delivered on the worksite. The remote control station 128 may accordingly identify those areas on the worksite which have not received any fluid and/or have not received the required volume of the fluid based on the mapping. In one embodiment, the remote control station 128 may transmit a command signal to an autonomous vehicle in order to deliver the fluid to these identified areas. Alternatively, the remote control station 128 may issue command or notification signals to the respective machines 100, 100′ to halt the discharge of the fluid in those areas that are flooded.

The controller 124, 124′ may embody a single microprocessor or multiple microprocessors that includes a means for receiving signals from the image capturing device 120, 120′ and the position detection module 122, 122′. Numerous commercially available microprocessors may be configured to perform the functions of the controller 124, 124′. It should be appreciated that the controller 124, 124′ may readily embody a general machine microprocessor capable of controlling numerous machine functions. A person of ordinary skill in the art will appreciate that the controller 124, 124′ may additionally include other components and may also perform other functionality not described herein. It should be understood that the embodiments and the configurations and connections explained herein are merely on an exemplary basis and may not limit the scope and spirit of the disclosure.

### Industrial Applicability

The present disclosure relates to the controller 124, 124′ that is present on-board the machine 100, 100′. The controller 124, 124′ is configured to detect when the fluid is being sprayed through the spray heads 108. Further, based on the location and the heading direction of the machine 100, 100′, the controller 124, 124′ is further configured to determine which area of the worksite has received the fluid thereon. The controller 124, 124′ provides a cost effective solution and may be easily integrated with or installed on a variety of systems.

In one embodiment, the remote control station 128 is configured to monitor the discharge of the fluid on various areas of the worksite by the respective machines 100, 100′ in order to effectively optimize the fluid distribution and productivity of the respective machines 100, 100′ on the worksite. Providing adequate quantities of the fluid to different areas of the worksite may reduce the formation of muddy spots on the worksite and may also result in improving overall fluid distribution on the worksite.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for a machine operating on a worksite, the system comprising:
an image capturing device configured to provide an image feed associated with a fluid dispensing arrangement of the machine;
a position detection module configured to generate a position signal indicative of a current position of the machine on the worksite; and
a controller communicably coupled to the image capturing device and the position detection module, the controller configured to:
receive the image feed;
receive the position signal;
detect a discharge of a fluid from the machine based on the image feed; and
determine an area of the worksite in which the fluid is discharged based on the detection and the position signal.
